(19) United States
(12) Patent Application Publication
(10) Pub. No.: US 2014/0052472 A1
(43) Pub. Date: Feb. 20, 2014

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Daigo AIZAWA, Kanagawa (JP)

(73) Assignee: FUJI XEROX CO., LTD., Tokyo (JP)

(21) Appl. No.: 13/778,407

(22) Filed: Feb. 27, 2013

(30) Foreign Application Priority Data
Aug. 17, 2012 (JP) 2012-180855

(51) Int. Cl. G06F 19/00

(52) U.S. Cl. CPC G06F 19/327; G06F 19/322
USPC 705/3

(57) ABSTRACT

An information processing apparatus includes a person-involved acquisition unit and a granting unit. The person-involved acquisition unit acquires person-involved information that specifies a medical staff member who is involved in a medical procedure scheduled to be performed on a patient. The granting unit grants, to the medical staff member specified by the person-involved information, a view privilege to view a medical record of the patient. The medical record is stored in a medical record memory that stores one or more medical records. The granting unit includes a role acquisition unit and a controller. The role acquisition unit acquires role information that specifies a role of the medical staff member in the medical procedure. The controller controls a valid period of the view privilege in accordance with the role of the medical staff member specified by the role information.

### CROSS-REFERENCE TO RELATED APPLICATIONS

This application is based on and claims priority under 35 USC 119 from Japanese Patent Application No. 2012-180855 filed Aug. 17, 2012.

### BACKGROUND

### Technical Field

The present invention relates to an information processing apparatus, an information processing method, and a non-transitory computer readable medium.

### SUMMARY

According to an aspect of the invention, there is provided an information processing apparatus including a person-involved acquisition unit and a granting unit. The person-involved acquisition unit acquires person-involved information that specifies a medical staff member who is involved in a medical procedure scheduled to be performed on a patient. The granting unit grants, to the medical staff member specified by the person-involved information, a view privilege to view a medical record of the patient, the medical record being stored in a medical record memory that stores one or more medical records. The granting unit includes a role acquisition unit and a controller. The role acquisition unit acquires role information that specifies a role of the medical staff member in the medical procedure. The controller controls a valid period of the view privilege in accordance with the role of the medical staff member specified by the role information.

### BRIEF DESCRIPTION OF THE DRAWINGS

An exemplary embodiment of the present invention will be described in detail based on the following figures, wherein:

FIG. 1 illustrates a configuration of a medical record management apparatus;

FIG. 2 illustrates contents stored in a medical record memory;

FIG. 3 illustrates schedule information;

FIG. 4 illustrates medical team information;

FIG. 5 is a flowchart illustrating a process performed by the medical record management apparatus;

FIG. 6 is a flowchart illustrating a process performed by the medical record management apparatus;

FIG. 7 illustrates contents stored in an importance memory;

FIG. 8 illustrates setting reference information; and

FIG. 9 illustrates access control information.

### DETAILED DESCRIPTION

An exemplary embodiment of the present invention will be described in detail below with reference to the accompanying drawings.

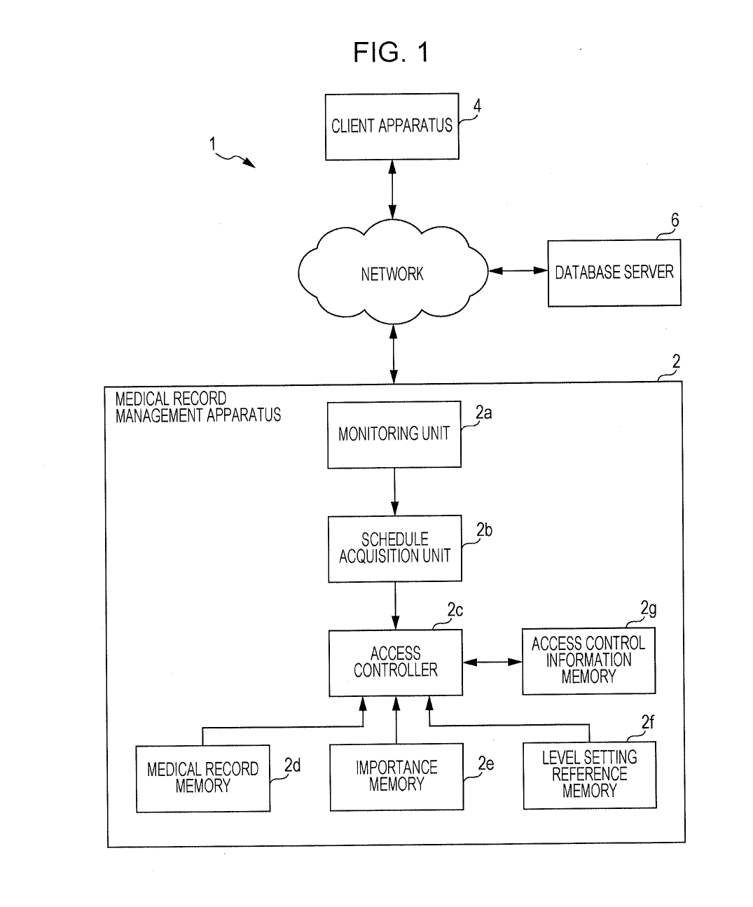

FIG. 1 illustrates a configuration of a medical record management apparatus 2, which is an information processing apparatus according to an exemplary embodiment. In this exemplary embodiment, the medical record management apparatus 2 is installed in a hospital (hereinafter, referred to as a hospital X) and is used for managing medical records of inpatients and outpatients of the hospital X. Specifically, the medical record management apparatus 2 is constructed as a server that includes a microprocessor, a main memory, a hard disk drive, a display, an operation input unit, and a network interface. The main memory stores a program that is read out from a computer readable information storage medium (e.g., a digital versatile disc-read only memory (DVD-ROM)). The microprocessor operates in accordance with this program, whereby a monitoring unit 2a, a schedule acquisition unit 2b, an access controller 2c, a medical record memory 2d, an importance memory 2e, a level setting reference memory 2f, and an access control information memory 2g are implemented in the medical record management apparatus 2. The program may be downloaded via a network and stored in the main memory.

The monitoring unit 2a, the schedule acquisition unit 2b, and the access controller 2c, which will be described later, are implemented by the microprocessor.

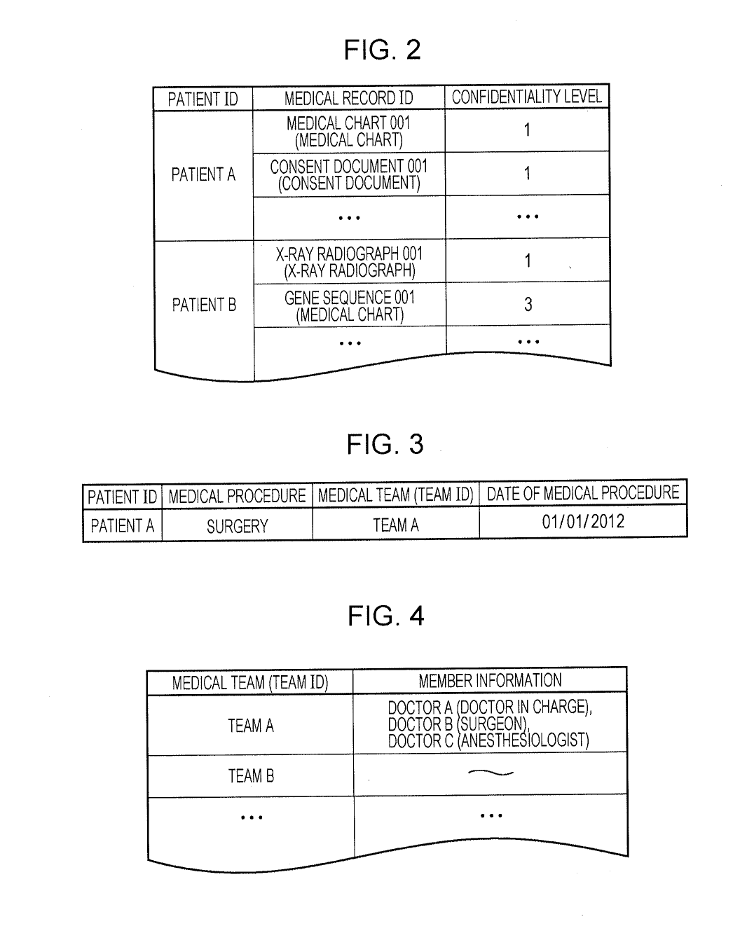

The medical record memory 2d is implemented by the hard disk drive. The medical record memory 2d stores medical records of individual patients. Examples of the medical records include medical charts, consent documents, X-ray radiographs, and gene sequences. The medical records are input by, for example, doctors and nurses who work at the hospital X. The medical record memory 2d also stores confidentiality level information that represents a confidentiality level of each medical record. The confidentiality level represents the confidentiality of the medical record in three steps, namely, “1” to “3”. The higher the confidentiality of the medical record, the higher the confidentiality level of the medical record. The medical record memory 2d also stores the type of medical record. The confidentiality level information and the type are input when the medical record is input. FIG. 2 illustrates contents stored in the medical record memory 2d. As illustrated in FIG. 2, the medical record memory 2d stores a medical record of a patient in association with the patient. Specifically, the medical record memory 2d stores a medical record ID of a medical record of a patient in association with a patient ID of the patient. The medical record memory 2d also stores the confidentiality level information representing the confidentiality level of the medical record in association with the medical record ID of the medical record. The medical record memory 2d also stores the type of the medical record. In FIG. 2, the type of the medical record is parenthesized.

Like the medical record memory 2d, the importance memory 2e, the level setting reference memory 2f, and the access control information memory 2g are implemented by the hard disk drive. Information stored in the importance memory 2e, the level setting reference memory 2f, and the access control information memory 2g will be described later.

As illustrated in FIG. 1, the medical record management apparatus 2 described above, a client apparatus 4 used by medical staff members who work at the hospital X, and a database server 6 constitute a medical record management system 1. The medical record management apparatus 2, the client apparatus 4, and the database server 6 are able to exchange data via a network.

The client apparatus 4 is used by the doctor who examines the patient or by the nurse to record the examination result as a medical record in the medical record management apparatus 2. The client apparatus 4 is also used by the doctor or by the nurse to access the medical record management apparatus 2 and view the medical record of the patient.

The client apparatus 4 is also used by a doctor in charge of the patient to register a schedule of a medical procedure to be performed on the patient to the database server 6. Specifically, the doctor in charge accesses the database server 6 and inputs the patient ID of the patient, the medical procedure information representing the type of medical procedure to be performed on the patient, date information representing the date on which the medical procedure is performed, and the team ID of the medical team that performs the medical procedure. As a result, schedule information that contains the information input by the doctor in charge is registered to the database server 6. FIG. 3 illustrates the schedule information stored in the database server 6. The schedule information is assigned a schedule ID (not illustrated) that is unique to the schedule information.

In this exemplary embodiment, the database server 6 stores medical team information that specifies members of plural predetermined medical teams and presents this medical team information. Thus, the doctor in charge selects one medical team suitable for the medical procedure to be performed on the patient with reference to the presented medical team information, thereby inputting the medical team. FIG. 4 illustrates the medical team information. As illustrated in FIG. 4, in the medical team information, the team ID of the medical team and member information that specifies members of the medical team are stored in association with each other. The member information also contains a role of each member in the medical team as illustrated in parentheses.

In this way, the schedule of the medical procedure to be performed on the patient is registered. After the schedule of the medical procedure to be performed on the patient is registered, a view privilege to view each medical record of the patient is granted to each of the members of the medical team.

Medical records (particularly, gene sequences) are sensitive information relating to privacy. Thus, the shorter valid period of the view privilege is more desirable in ordinary situations. Regarding this point, in this medical record management system 1, the valid period of the view privilege to be granted to each member is controlled in consideration of a circumstance of the member who performs the medical procedure. Specifically, the valid period is controlled in consideration of the role of each member. Accordingly, for example, a view privilege with a relatively long valid period is granted to a member having a role that needs to view the medical record frequently, whereas a view privilege with a relatively short valid period is granted to a member having a role that needs to view the medical record less frequently.

The following describes this point.

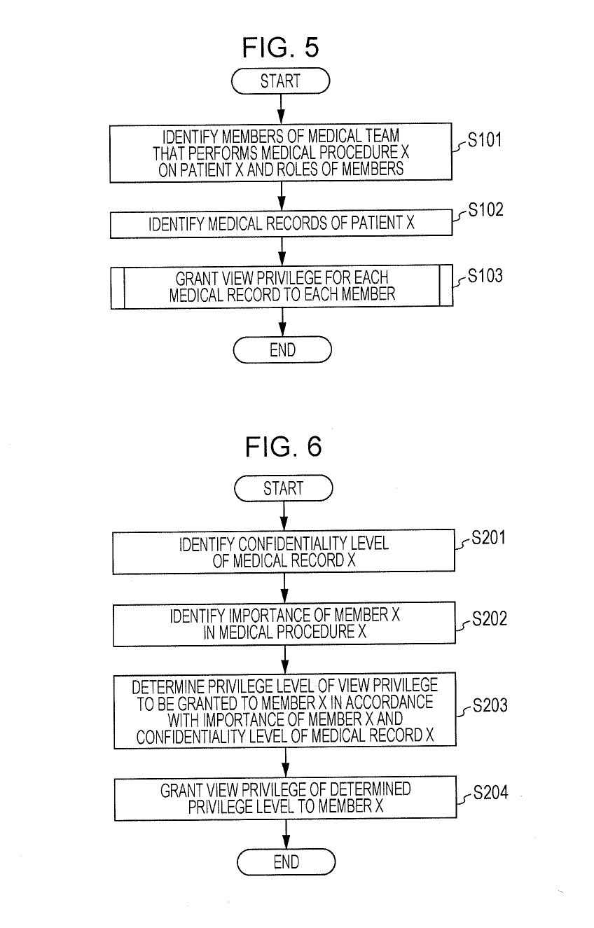

FIG. 5 is a flowchart illustrating a process performed by the medical record management apparatus 2. In the medical record management apparatus 2, the monitoring unit 2a (see FIG. 1) monitors registration of schedule information to the database server 6. The process illustrated in FIG. 5 is performed after the schedule information is registered to the database server 6.

FIG. 5 will be described below, in which the schedule information registered to the database server 6 is referred to as schedule information X. It is assumed here that the schedule information X is schedule information that is created when a schedule of a medical procedure X to be performed on a patient X is registered. Accordingly, the schedule information X contains the patient ID of the patient X and the medical procedure information representing the medical procedure X.

First, the schedule acquisition unit 2b (which serves as a person-involved acquisition unit and a role acquisition unit) identifies members of a medical team that performs the medical procedure X on the patient X and roles of the individual members (S101). Specifically, the schedule acquisition unit 2b acquires the schedule information X from the database server 6 and acquires the team ID contained in the schedule information X. The schedule acquisition unit 2b then acquires the medical team information from the database server 6 and acquires the member information associated with the acquired team ID.

In addition, the access controller 2c identifies medical records of the patient X (S102). Specifically, the access controller 2c reads out, from the medical record memory 2d, the medical record IDs associated with the patient ID of the patient X that is contained in the schedule information X.

Then, the access controller 2c (which serves as a granting unit) grants a view privilege for each medical record to each of the members (S103). At this time, the access controller 2c grants the view privilege in consideration of the role of the member and the confidentiality level of the medical record. Specifically, a process illustrated in a flowchart of FIG. 6 is performed for each combination of a member and a medical record. The process illustrated in FIG. 6 will be described below regarding a case where the view privilege for the medical record X is granted to a member X.

First, the access controller 2c (which serves as an identification unit) identifies the confidentiality level of the medical record X (S201). Specifically, the access controller 2c reads out, from the medical record memory 2d, the confidentiality level information associated with the medical record ID of the medical record X.

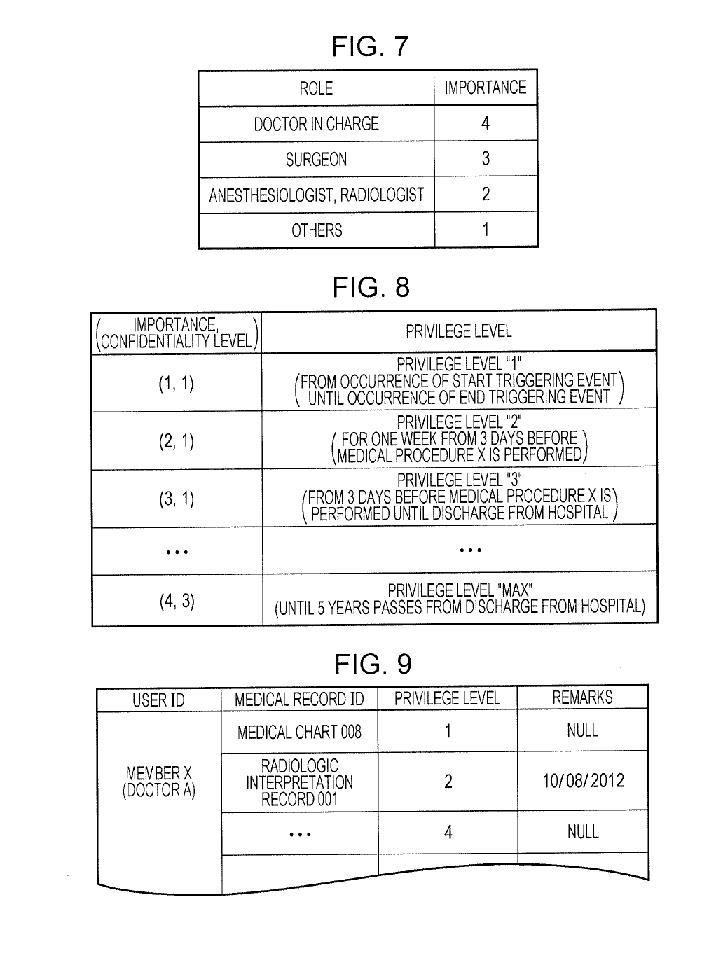

The access controller 2c also identifies importance of the member X in the medical procedure X from the role of the member X (S202). Specifically, the importance memory 2e pre-stores importance information that represents importance of each role in association with the role. FIG. 7 illustrates contents stored in the importance memory 2e. In step S202, the access controller 2c reads out, from the importance memory 2e, the importance information associated with the role of the member X.

Then, the access controller 2c (which serves as the granting unit) performs processing of S203 and S204 to grant the view privilege for the medical record X to the member X in accordance with the importance of the member X and the confidentiality level of the medical record X. In this way, the access controller 2c (which serves as a controller) grants, to the member X, the view privilege of a level that is based on the importance of the member X and the confidentiality level of the medical record X.

In this exemplary embodiment, the level setting reference memory 2f stores setting reference information. FIG. 8 illustrates the setting reference information. As illustrated in FIG. 8, in the setting reference information, the privilege level of the view privilege is stored in association with a combination of the importance and the confidentiality level. In this exemplary embodiment, the valid period of the view privilege of the privilege level “1” is a period from the occurrence of a certain start triggering event until the occurrence of a certain end triggering event. Examples of the start triggering event include the occurrence of a request for an X-ray examination. Examples of the end triggering event include completion of the X-ray examination.

The valid period of the view privilege of the privilege level “2” is a period of one week starting three days before the medical procedure X is performed. The valid period of the view privilege of the privilege level “3” is a period starting three days before the medical procedure X is performed until discharge from the hospital. The valid period of the view privilege of the privilege level “MAX” is up until five years from discharge from the hospital.

In S203 and S204, the view privilege of one of the privilege levels is granted to the member X in accordance with this setting reference information.

Specifically, based on the importance of the member X and the confidentiality level of the medical record X, the access controller 2c (which serves as the granting unit and the controller) determines the privilege level of the view privilege to be granted to the member X (S203). More specifically, the access controller 2c refers to the setting reference information, and reads out, from the level setting reference memory 2f, the privilege level associated with the condition satisfied by the combination of the importance of the member X and the confidentiality level of the medical record X.

Then, the access controller 2c (which serves as the granting unit) grants, to the member X, the view privilege of the privilege level determined in S203 for the medical record X (S204). In this exemplary embodiment, the access control information memory 2g stores access control information for each user. FIG. 9 illustrates the access control information of the member X. As illustrated in FIG. 9, in the access control information, entries regarding medical records that the member X is authorized to view are stored in association with the user ID of the member X. Each entry contains the medical record ID of the medical record, the privilege level of the view privilege, and remark information. Based on the access control information of the member X, access to each medical record made by the member X is controlled. When the valid period of the view privilege for a medical record expires, the entry regarding the medical record is deleted.

In S204, the access controller 2c updates the access control information of the member X, thereby granting the view privilege for the medical record X to the member X. Specifically, the access controller 2c newly associates an entry regarding the medical record X with the user ID of the member X. More specifically, the access controller 2c associates an entry that contains the medical record ID of the medical record X, the privilege level determined in S203, and the remark information, with the user ID of the member X. If the privilege level determined in S203 is not “2” or “3”, “null” is set in the remark information. In the other cases, date information contained in the schedule information X is used as the remark information.

Exemplary embodiments of the present invention are not limited to the above-described one.

For example, the process illustrated in FIG. 5 may be regularly performed in addition to after registration of schedule information. Also, for example, the database server 6 may be omitted. In this case, the information stored in the database server 6 may be stored in the medical record management apparatus 2.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a person-involved acquisition unit that acquires person-involved information that specifies a medical staff member who is involved in a medical procedure scheduled to be performed on a patient; and
a granting unit that grants, to the medical staff member specified by the person-involved information, a view privilege to view a medical record of the patient, the medical record being stored in a medical record memory that stores one or more medical records,
wherein the granting unit includes
a role acquisition unit that acquires role information that specifies a role of the medical staff member in the medical procedure, and
a controller that controls a valid period of the view privilege in accordance with the role of the medical staff member specified by the role information.

2. The information processing apparatus according to claim 1,
wherein each of the one or more medical records stored in the medical record memory is assigned a confidentiality level that represents a degree of confidentiality of the medical record,
wherein the granting unit further includes
an identification unit that identifies the confidentiality level assigned to the medical record of the patient, and
wherein the controller controls the valid period of the view privilege in accordance with the role of the medical staff member specified by the role information and the confidentiality level identified by the identification unit.

3. An information processing method comprising:
acquiring person-involved information that specifies a medical staff member who is involved in a medical procedure scheduled to be performed on a patient; and
granting, to the medical staff member specified by the person-involved information, a view privilege to view a medical record of the patient, the medical record being stored in a medical record memory that stores one or more medical records,
wherein the granting includes
acquiring role information that specifies a role of the medical staff member in the medical procedure, and
controlling a valid period of the view privilege in accordance with the role of the medical staff member specified by the role information.

4. A non-transitory computer readable medium storing a program causing a computer to execute a process for information processing, the process comprising:
acquiring person-involved information that specifies a medical staff member who is involved in a medical procedure scheduled to be performed on a patient; and
granting, to the medical staff member specified by the person-involved information, a view privilege to view a medical record of the patient, the medical record being stored in a medical record memory that stores one or more medical records,
wherein the granting includes
acquiring role information that specifies a role of the medical staff member in the medical procedure, and
controlling a valid period of the view privilege in accordance with the role of the medical staff member specified by the role information.
